(19) United States
(12) Patent Application Publication
(10) Pub. No.: US 2024/0018348 A1
(43) Pub. Date: Jan. 18, 2024

(54) Thermoplastic Resin Composition and Molded Product Using Same

(71) Applicant: LOTTE CHEMICAL CORPORATION, Seoul (KR)

(72) Inventors: Hyeongseob SHIN, Uiwang-si (KR); Keehae KWON, Uiwang-si (KR); In-Chol KIM, Uiwang-si (KR); Jaekeun HONG, Uiwang-si (KR)

(21) Appl. No.: 18/270,573

(22) PCT Filed: Dec. 29, 2021
(86) PCT No.: PCT/KR2021/020205

§ 371 Date: Jun. 30, 2023

(30) Foreign Application Priority Data
Dec. 31, 2020 (KR) 10-2020-0189438

(51) Int. Cl. C08L 25/16; C08L 33/12

(52) U.S. Cl. CPC C08L 25/16; C08L 33/12; C08L 2205/025; C08L 2205/035; C08L 2207/53

(57) ABSTRACT

Provided are a thermoplastic resin composition and a molded product using the same, the thermoplastic resin composition including (A) 10 wt % to 30 wt % of an acrylate-based rubber modified aromatic vinyl-vinyl cyanide graft copolymer; (B) 10 wt % to 30 wt % of a composite rubber modified aromatic vinyl-vinyl cyanide graft copolymer; (C) 10 wt % to 40 wt % of a polyalkyl (meth)acrylate resin; and (D) 20 wt % to 50 wt % of an alpha-methylstyrene-based copolymer.

### TECHNICAL FIELD

The present invention relates to a thermoplastic resin composition and a molded product using the same.

### BACKGROUND ART

Recently, a thermoplastic resin variously applied to electric/electronic products, automobiles, construction materials, leisure goods, and the like has been rapidly replacing a conventional glass or metal area. Accordingly, demand for a thermoplastic resin capable of realizing improved impact resistance, weather resistance, molding processability, and high-quality appearance is being increased.

In general, when an acrylonitrile-butadiene-styrene copolymer resin (hereinafter, ABS resin) is used as the thermoplastic resin, since the ABS resin includes a chemically unstable double bond in a rubber component, and the rubber component may be easily aged by ultraviolet (UV), weather resistance and light resistance are not sufficient. Accordingly, when left outside for a long time, the ABS resin is discolored and exhibits large property deterioration, as time passes and accordingly, is not suitable for outdoor use exposed to sunlight.

On the contrary, an acrylonitrile-styrene-acrylate copolymer resin (hereinafter, ASA resin) uses a chemically stable acrylate-based rubbery polymer instead of the butadiene-based rubbery polymer as the rubber component and thus is known to solve the discoloring and property deterioration problems of the ABS resin according to aging of the rubber component due to ultraviolet (UV). In addition, the ASA resin has improved moldability, chemical resistance, and thermal stability and the like as well as weather resistance.

Recently, requirements for a non-painted thermoplastic resin usable without a painting process have been increased according to an environmentally-friendly trend. The non-painted thermoplastic resin should have excellent scratch resistance, colorability, impact resistance, weather resistance, and the like, for a non-painted molded product is used as it is, and as the level of property requirements has recently been increased, more and more attempts to apply an ASA/PMMA alloy resin in which an ASA resin is mixed with a polymethyl methacrylate resin (hereinafter, PMMA resin) have been made.

However, since the ASA/PMMA alloy resin lacks impact resistance and heat resistance, compared with the ASA resin, in particular, when a heat resistance reinforcing agent is used to compensate for the heat resistance, which may deteriorate transparency and colorability of a molded product due to a refractive index difference between continuous phase (matrix) and dispersed phase (domain), a colorant such as a pigment, a dye, and the like may be used in an excessive amount for coloring the molded product.

Accordingly, research on a thermoplastic resin composition having excellent impact resistance, heat resistance, scratch resistance, fluidity, and colorability is required.

### DISCLOSURE

### Description of the Drawings

### Technical Problem

An embodiment provides a thermoplastic resin composition having excellent impact resistance, heat resistance, scratch resistance, fluidity, and colorability, and a molded product using the same.

### Technical Solution

According to an embodiment, a thermoplastic resin composition includes (A) 10 wt % to 30 wt % of an acrylate-based rubber modified aromatic vinyl-vinyl cyanide graft copolymer; (B) 10 wt % to 30 wt % of a composite rubber modified aromatic vinyl-vinyl cyanide graft copolymer; (C) 10 wt % to 40 wt % of a polyalkyl (meth)acrylate resin; and (D) 20 wt % to 50 wt % of an alpha-methylstyrene-based copolymer.

The (A) acrylate-based rubber modified aromatic vinyl-vinyl cyanide graft copolymer may include a core including an acrylate-based rubbery polymer, and a shell formed by grafting a monomer mixture including an aromatic vinyl compound and a vinyl cyanide compound to the core.

The acrylate-based rubbery polymer may be a crosslinked polymer prepared by using an acrylate-based compound including ethyl acrylate, butyl acrylate, 2-ethylhexyl acrylate, hexyl acrylate, or a combination thereof as a main monomer, and the acrylate-based rubbery polymer may be included in an amount of 20 wt % to 60 wt % based on 100 wt % of the (A) acrylate-based rubber modified aromatic vinyl-vinyl cyanide graft copolymer.

The shell may be a copolymer of a monomer mixture including an aromatic vinyl compound and a vinyl cyanide compound in a weight ratio of 1:1 to 4:1.

The acrylate-based rubbery polymer may have an average particle diameter of 100 nm to 200 nm.

The (A) acrylate-based rubber modified aromatic vinyl-vinyl cyanide graft copolymer may be an acrylonitrile-styrene-acrylate graft copolymer.

The (B) composite rubber modified aromatic vinyl-vinyl cyanide graft copolymer may include a core including a composite rubber polymer, and a shell formed by grafting a monomer mixture including an aromatic vinyl compound and a vinyl cyanide compound to the core.

The composite rubber polymer may include a crosslinked copolymer of an acrylate-based compound-silicone-based compound or a mixture of an acrylate-based rubbery polymer and a silicone-based rubbery polymer, and the composite rubber polymer may have an average particle diameter of 100 nm to 200 nm.

The (B) composite rubber modified aromatic vinyl-vinyl cyanide graft copolymer may be a copolymer having a core-shell structure in which a styrene-acrylonitrile copolymer (SAN) forms a shell on a core of a crosslinked copolymer of an acrylate-based compound-silicone-based compound.

The (C) polyalkyl (meth)acrylate resin may have a glass transition temperature of 100° C. to 150° C.

The (C) polyalkyl (meth)acrylate resin may be a polymethyl methacrylate (PMMA) resin.

The (D) alpha-methylstyrene-based copolymer may be a copolymer of a monomer mixture including 50 wt % to 60 wt % of alpha-methylstyrene, 15 wt % to 28 wt % of a vinyl cyanide compound, and 15 wt % to 35 wt % of an aromatic vinyl compound, and in the (D) alpha-methylstyrene-based copolymer, the aromatic vinyl compound may be selected from styrene that is substituted or unsubstituted with a halogen or a C1 to C10 alkyl group (but not including alpha-methylstyrene) and a combination thereof, and the vinyl cyanide compound may be selected from acrylonitrile, methacrylonitrile, fumaronitrile, and a combination thereof.

The (D) alpha-methylstyrene-based copolymer may be an alpha-methylstyrene-styrene-acrylonitrile copolymer.

The thermoplastic resin composition may further include at least one additive selected from a flame retardant, a nucleating agent, a coupling agent, a filler, a plasticizer, an impact-reinforcing agent, a lubricant, an antibacterial agent, a release agent, a heat stabilizer, an antioxidant, an inorganic material additive, an ultraviolet (UV) stabilizer, an antistatic agent, a pigment, and a dye.

According to another embodiment, a molded product including the aforementioned thermoplastic resin composition is provided.

### Advantageous Effects

The thermoplastic resin composition having improved impact resistance, heat resistance, and colorability, and a molded product using the same are provided.

### MODE FOR INVENTION

Hereinafter, embodiments of the present invention are described in detail. However, these embodiments are exemplary, the present invention is not limited thereto and the present invention is defined by the scope of claims.

In the present specification, unless otherwise mentioned, “copolymerization” refers to a block copolymerization, a random copolymerization, or a graft-copolymerization and “copolymer” refers to a block copolymer, a random copolymer, or a graft copolymer.

In the present specification, unless otherwise mentioned, the average particle diameter of the rubbery polymer refers to a volume average diameter, and means a Z-average particle diameter measured using a dynamic light scattering analysis equipment.

In the present specification, unless otherwise mentioned, the weight average molecular weight is measured by dissolving a powder sample in an appropriate solvent and then performing gel permeation chromatography (GPC) with a 1200 series made by Agilent Technologies Inc. (a column is LF-804 made by Shodex and a standard sample is polystyrene made by Shodex).

In the present specification, unless otherwise mentioned, “(meth)acrylate” refers to acrylate and methacrylate.

An embodiment provides a thermoplastic resin composition having improved impact resistance, heat resistance, and colorability.

The thermoplastic resin composition includes (A) 10 to 30 wt % of an acrylate-based rubber modified aromatic vinyl-vinyl cyanide graft copolymer; (B) 10 to 30 wt % of a composite rubber modified aromatic vinyl-vinyl cyanide graft copolymer; (C) 10 to 40 wt % of a polyalkyl (meth)acrylate resin; and (D) 20 to 50 wt % of an alpha-methylstyrene-based copolymer.

Hereinafter, each component of the thermoplastic resin composition is described in detail.

### (A) Acrylate-Based Rubber Modified Aromatic Vinyl-Vinyl Cyanide Graft Copolymer

In an embodiment, the (A) acrylate-based rubber modified aromatic vinyl-vinyl cyanide graft copolymer imparts improved impact resistance to the thermoplastic resin composition. The (A) acrylate-based rubber modified aromatic vinyl-vinyl cyanide graft copolymer may include a core including an acrylate-based rubbery polymer, and a shell formed by grafting a monomer mixture including an aromatic vinyl compound and a vinyl cyanide compound to the core.

The (A) acrylate-based rubber modified aromatic vinyl-vinyl cyanide graft copolymer may be prepared by any method known to those skilled in the art.

The preparation method may be a conventional polymerization method, for example, emulsion polymerization, suspension polymerization, solution polymerization, bulk polymerization, or the like. For a non-limiting example, it may be prepared by a method including preparing an acrylate-based rubbery polymer and graft-polymerizing a monomer mixture including an aromatic vinyl compound and a vinyl cyanide compound, on a core formed of one or more layers of the acrylate-based rubbery polymer, to form one or more shells.

The acrylate-based rubbery polymer may be a crosslinked polymer prepared by using an acrylate-based compound as a main monomer. The acrylate-based compound may be for example ethyl acrylate, butyl acrylate, 2-ethylhexyl acrylate, hexyl acrylate, or a combination thereof, but is not limited thereto.

The acrylate-based rubbery polymer may have an average particle diameter of 100 to 200 nm, or for example 120 to 180 nm. Within the above average particle diameter range, the thermoplastic resin composition may have improved mechanical properties such as impact resistance and tensile strength, and colorability.

The acrylate-based compound may be copolymerized with one or more other radically polymerizable monomer compound. When copolymerized, an amount of the one or more other radically polymerizable monomer compound may be 5 to 30 wt %, or for example 10 to 20 wt % based on a total weight of the acrylate-based rubbery polymer.

The aromatic vinyl compound included in the shell may be at least one selected from styrene, α-methylstyrene, p-methylstyrene, p-t-butylstyrene, 2,4-dimethylstyrene, chlorostyrene, vinyltoluene, or vinylnaphthalene, but is not limited thereto.

The vinyl cyanide compound included in the shell may be at least one selected from acrylonitrile, methacrylonitrile, and fumaronitrile, but is not limited thereto.

The acrylate-based rubbery polymer may be included in 20 to 60 wt %, for example 30 to 60 wt %, for example 40 to 60 wt % based on 100 wt % of the (A) acrylate-based rubber modified aromatic vinyl-vinyl cyanide graft copolymer.

In the shell formed by graft-polymerizing the monomer mixture including the aromatic vinyl compound and the vinyl cyanide compound on the acrylate-based rubbery polymer, the shell may be a copolymer of the monomer mixture of the aromatic vinyl compound and the vinyl cyanide compound in a weight ratio of 1:1 to 4:1, or for example 1:1 to 3:1.

In an embodiment, the (A) acrylate-based rubber modified aromatic vinyl-vinyl cyanide graft copolymer may be an acrylonitrile-styrene-acrylate graft copolymer.

The (A) acrylate-based rubber modified aromatic vinyl-vinyl cyanide graft copolymer may be included in an amount of greater than or equal to 10 wt %, or for example, greater than or equal to 15 wt % and for example, less than or equal to 30 wt %, for example, less than or equal to 25 wt %, or for example 10 to 30 wt %, for example 15 to 25 wt % based on 100 wt % of the sum of components (A) to (D). Within the above weight range, the thermoplastic resin composition may have improved impact resistance, mechanical properties, and colorability.

### (B) Composite Rubber Modified Aromatic Vinyl-Vinyl Cyanide Graft Copolymer

In an embodiment, the (B) composite rubber modified aromatic vinyl-vinyl cyanide graft copolymer imparts improved impact resistance to the thermoplastic resin composition. The (B) composite rubber modified aromatic vinyl-vinyl cyanide graft copolymer may include a core including a composite rubber polymer, and a shell formed by grafting a monomer mixture including an aromatic vinyl compound and a vinyl cyanide compound to the core.

The (B) composite rubber modified aromatic vinyl-vinyl cyanide graft copolymer may be prepared by using emulsion polymerization, suspension polymerization, solution polymerization, and bulk polymerization and may be for example, prepared by a method of preparing a composite rubber polymer and graft polymerizing a monomer mixture including an aromatic vinyl compound and a vinyl cyanide compound to a core in which the composite rubber polymer is formed of one or more layers to form a shell of one or more layers, but is not limited thereto.

The composite rubber polymer may be a crosslinked copolymer of an acrylate-based compound-silicone-based compound, or a mixture of an acrylate-based rubbery polymer and a silicone-based rubbery polymer.

The acrylate-based rubbery polymer may be a crosslinked polymer prepared by using an acrylate-based compound as a main monomer. The acrylate-based compound may be, for example, ethyl acrylate, butyl acrylate, 2-ethylhexyl acrylate, hexyl acrylate, or a combination thereof, but is not limited thereto.

The silicone-based rubbery polymer may be a crosslinked polymer prepared by using a silicone-based compound as a main monomer. The silicone-based compound may be, for example, dimethyl siloxane, methylphenyl siloxane, methylvinyl siloxane, or a combination thereof, but is not limited thereto.

The composite rubber polymer may have an average particle diameter of 100 to 200 nm, or for example, 120 to 180 nm. Within the above average particle diameter range, the thermoplastic resin composition may have improved impact resistance and colorability.

In the composite rubber polymer, a weight ratio of the component derived from the acrylate-based compound and the component derived from the silicone-based compound may be 95:5 to 85:15, or for example, 95:5 to 90:10. Within this range, the thermoplastic resin composition may have improved impact resistance and colorability.

The aromatic vinyl compound included in the shell may be at least one selected from styrene, α-methylstyrene, p-methylstyrene, p-t-butylstyrene, 2,4-dimethylstyrene, chlorostyrene, vinyltoluene, and vinylnaphthalene, but is not limited thereto.

The vinyl cyanide compound included in the shell may be at least one selected from acrylonitrile, methacrylonitrile, and fumaronitrile, but is not limited thereto.

The composite rubber polymer may be included in 20 to 60 wt %, for example 30 to 60 wt %, or for example 40 to 60 wt % based on 100 wt % of the (B) composite rubber modified aromatic vinyl-vinyl cyanide graft copolymer.

In a shell formed by graft polymerization of a monomer mixture including the aromatic vinyl compound and the vinyl cyanide compound to the rubbery polymer, the shell may be a copolymer of a monomer mixture including the aromatic vinyl compound and the vinyl cyanide compound in a weight ratio of 1:1 to 4:1, or for example 1:1 to 3:1.

In an embodiment, the (B) composite rubber modified aromatic vinyl-vinyl cyanide graft copolymer may be a copolymer having a core-shell structure in which a styrene-acrylonitrile copolymer (SAN) forms a shell on a core of a crossl inked copolymer of an acrylate-based compound-silicone-based compound.

The (B) composite rubber modified aromatic vinyl-vinyl cyanide graft copolymer may be included in an amount of greater than or equal to 10 wt %, for example greater than or equal to 15 wt % and for example less than or equal to 30 wt %, or for example less than or equal to 25 wt %, for example 10 to 30 wt %, or for example 15 to 25 wt % based on 100 wt % of the sum of components (A) to (D). Within the above weight range, the thermoplastic resin composition may have improved impact resistance, fluidity, and colorability.

### (C) Polyalkyl (Meth)Acrylate Resin

In an embodiment, the (C) polyalkyl (meth)acrylate resin may impart scratch resistance to the thermoplastic resin composition. The (C) polyalkyl (meth)acrylate resin may be prepared by polymerizing an alkyl (meth)acrylate by a known polymerization method such as suspension polymerization, bulk polymerization, or emulsion polymerization.

The alkyl (meth)acrylate may be methyl (meth)acrylate, ethyl (meth)acrylate, butyl (meth)acrylate, glycidyl (meth)acrylate, 2-hydroxyethyl (meth)acrylate, cyclohexyl (meth)acrylate, or a combination thereof, but is not limited thereto.

In an embodiment, the (C) polyalkyl (meth)acrylate resin may be a polymethyl methacrylate resin.

The polymethyl methacrylate resin may be a copolymer of a monomer mixture including 80 to 99 wt % of methyl methacrylate and 1 to 20 wt % of methyl acrylate.

The (C) polyalkyl (meth)acrylate resin may have a glass transition temperature of 100 to 150° C., or for example 110 to 130° C.

The (C) polyalkyl (meth)acrylate resin may have a weight average molecular weight of 50,000 to 200,000 g/mol, or for example, 70,000 to 150,000 g/mol. The weight average molecular weight is a molecular weight, reduced to polystyrene measured using gel permeation chromatography (GPC). Within the above range, the thermoplastic resin composition including the same may exhibit improved scratch resistance and fluidity.

The (C) polyalkyl (meth)acrylate resin may be included in an amount of greater than or equal to 10 wt %, or for example, greater than or equal to 15 wt %, and for example, less than or equal to 40 wt %, for example, less than or equal to 35 wt %, for example, 10 to 40 wt %, for example, 15 to 35 wt %, or for example, 20 to 35 wt % based on 100 wt % of the sum of components (A) to (D). Within the above weight range, the thermoplastic resin composition may have improved scratch resistance.

### (D) Alpha-Methylstyrene (α-Methylstyrene)-Based Copolymer

The (D) alpha-methylstyrene-based copolymer may improve heat resistance of the thermoplastic resin composition.

The (D) alpha-methylstyrene-based copolymer may be prepared by using a conventional preparing method, for example, emulsion polymerization, suspension polymerization, solution polymerization, bulk polymerization, and the like.

In an embodiment, the (D) alpha-methylstyrene-based copolymer may be a copolymer of a monomer mixture including 50 to 60 wt % of alpha-methylstyrene, 15 to 28 wt % of a vinyl cyanide compound, and 15 to 35 wt % of an aromatic vinyl compound. Within the above weight range, the thermoplastic resin composition may have improved compatibility, heat resistance, and weather resistance.

In the (D) alpha-methylstyrene-based copolymer, the aromatic vinyl compound may be selected from styrene that is substituted or unsubstituted with a halogen or a C1 to C10 alkyl group (but not including alpha-methylstyrene) and a combination thereof, and the vinyl cyanide compound may be selected from acrylonitrile, methacrylonitrile, fumaronitrile, and a combination thereof.

In an embodiment, the (D) alpha-methylstyrene-based copolymer may be an alpha-methylstyrene-styrene-acrylonitrile copolymer.

The (D) alpha-methylstyrene-based copolymer may have a weight average molecular weight of 50,000 to 300,000 g/mol, or for example, 100,000 to 200,000 g/mol.

The weight average molecular weight is a molecular weight, reduced to polystyrene measured using gel permeation chromatography (GPC). When the above range is satisfied, the thermoplastic resin composition including the same may exhibit improved impact resistance and fluidity.

The (D) alpha-methylstyrene-based copolymer may be included in an amount of greater than or equal to 20 wt %, for example, greater than or equal to 25 wt %, and for example, less than or equal to 50 wt %, for example, less than or equal to 45 wt %, or for example, 20 to 50 wt %, or for example, 25 to 45 wt % based on 100 wt % of the sum of components (A) to (D). Within the above weight range, the thermoplastic resin composition may have improved heat resistance, weather resistance, and appearance characteristics.

### (E) Other Additives

The thermoplastic resin composition according to an embodiment may further include at least one type of additive which is required for a final use of the thermoplastic resin composition or property balance under a condition of excellently maintaining moldability and other properties during processing and use in addition to the components (A) to (D).

Specifically, the additive may be a flame retardant, a nucleating agent, a coupling agent, a filler, a plasticizer, a lubricant, an antibacterial agent, a release agent, a heat stabilizer, an antioxidant, an inorganic material additive, ultraviolet (UV) stabilizer, an antistatic agent, a pigment, a dye, and the like, which may be used alone or in a combination of two or more.

These additives may be appropriately included, unless properties of the thermoplastic resin composition are deteriorated, and specifically, included in an amount of less than or equal to about 20 parts by weight based on 100 parts by weight of the sum of the components (A) to (D), but are not limited thereto.

On the other hand, the thermoplastic resin composition of an embodiment may be mixed with other resins or other rubber components.

On the other hand, another embodiment provides a molded product including the thermoplastic resin composition according to an embodiment. The molded product may be manufactured in various methods publicly known in the related art, for example, a method of injection molding, extrusion molding, and the like by using the thermoplastic resin composition.

The molded product may be advantageously used for various electronic parts, construction materials, leisure goods, auto parts, and the like, requiring improved light resistance or weather resistance.

In particular, the molded product may be used as an automobile exterior material that can be unpainted, and specifically, may be used for automobile door pillars, radiator grills, side mirror housings, and the like. However, the use of the molded product is not limited thereto.

Hereinafter, preferred examples of the present invention will be described. These examples, however, are not in any sense to be interpreted as limiting the scope of the invention.

### EXAMPLES

The components shown in Tables 1 and 2.5 parts by weight of a black pigment (carbon black) for easy evaluation colorability based on 100 parts by weight of the total weight of the (A) to (E), 0.5 parts by weight of the additives such as common antioxidants and lubricants, etc. were mixed in a conventional mixer and extruded at a barrel temperature of about 240° C. using a twin screw extruder having L/D=29 and ϕ=45 mm to prepare pellet-shaped thermoplastic resin compositions.

The prepared pellets were dried in an about 80° C. dehumidifying drier for about 4 hours before injection molding and then, injection-molded by using a 6 oz injection molding machine set at a cylinder temperature of about 240° C. and at a mold temperature of about 60° C. to prepare specimens for evaluation of physical properties and specimens for evaluation of colorability. The measured physical properties are shown in Table 2.

In Table 1, each component is shown in wt % based on the total weight of (A) to (E).

TABLE 1

| | Examples | | | | | | | Comparative Examples | | | | | | | |
|---|---|---|---|---|---|---|---|---|---|---|---|---|---|---|---|
| | 1 | 2 | 3 | 4 | 5 | 6 | 7 | 1 | 2 | 3 | 4 | 5 | 6 | 7 | 8 |
| (A) | 20 | 20 | 20 | 20 | 20 | 30 | 10 | — | 20 | 20 | 20 | 30 | 40 | — | 20 |
| (A-1) | — | — | — | — | — | — | — | 20 | — | — | — | — | — | — | — |
| (B) | 20 | 20 | 20 | 20 | 20 | 10 | 30 | 20 | 20 | 20 | 20 | 20 | — | 40 | 20 |
| (C) | 10 | 20 | 40 | 20 | 20 | 20 | 20 | 20 | 20 | 60 | — | 20 | 20 | 20 | 20 |
| (D-1) | — | — | — | 40 | — | — | — | — | — | — | — | — | — | — | — |
| (D-2) | — | — | — | — | 40 | — | — | — | — | — | — | — | — | — | — |
| (D-3) | 50 | 40 | 20 | — | — | 40 | 40 | 40 | — | — | 60 | — | 40 | 40 | — |
| (D-4) | — | — | — | — | — | — | — | — | 40 | — | — | 30 | — | — | — |
| (E) | — | — | — | — | — | — | — | — | — | — | — | — | — | — | 40 |

### (A) Acrylate-Based Rubber Modified Aromatic Vinyl-Vinyl Cyanide Graft Copolymer

An acrylonitrile-styrene-acrylate graft copolymer (g-ASA) of a core-shell structure including about 50 wt % of a core including a butyl acrylate rubbery polymer and having an average particle diameter of about 120 nm and a shell formed by grafting styrene and acrylonitrile in a weight ratio of about 2:1 to the core was used (Manufacturer: Lotte Chemical Corporation).

### (A-1) Acrylate-Based Rubber Modified Aromatic Vinyl-Vinyl Cyanide Graft Copolymer

A acrylonitrile-styrene-acrylate graft copolymer (g-ASA) of a core-shell structure comprising about 50 wt % of a core including a butyl acrylate rubbery polymer and having an average particle diameter of about 330 nm and a shell formed by grafting styrene and acrylonitrile in a weight ratio of about 2:1 to the core was used (Manufacturer: Lotte Chemical Corp.).

### (B) Composite Rubber Modified Aromatic Vinyl-Vinyl Cyanide Graft Copolymer

An acrylonitrile-silicone/acrylate-styrene graft copolymer of a core-shell structure comprising about 50 wt % of a core including a crosslinked copolymer of an acrylate-based compound-silicone-based compound and having an average particle diameter of about 150 nm and a shell formed by grafting styrene and acrylonitrile in a weight ratio of about 2:1 to the core was used (Manufacturer: Mitsubishi Chemical Corp.).

### (C) Polyalkyl (Meth)Acrylate Resin

A polymethyl methacrylate resin having a glass transition temperature of about 120° C. and a weight average molecular weight of about 85,000 g/mol was used (Manufacturer: Arkema).

### (D-1) Alpha-Methylstyrene-Based Copolymer

An alpha-methylstyrene-styrene-acrylonitrile copolymer prepared by copolymerizing a monomer mixture of about 30 wt % of styrene, about 16 wt % of acrylonitrile, and about 54 wt % of alpha-methylstyrene and having a weight average molecular weight of about 160,000 g/mol was used (Manufacturer: Lotte Chemical Corp.).

### (D-2) Alpha-Methylstyrene-Based Copolymer

An alpha-methylstyrene-styrene-acrylonitrile copolymer prepared by copolymerizing a monomer mixture of about 26 wt % of styrene, about 20 wt % of acrylonitrile, and about 54 wt % of alpha-methylstyrene and having a weight average molecular weight of about 160,000 g/mol was used (Manufacturer: Lotte Chemical Corp.).

### (D-3) Alpha-Methylstyrene-Based Copolymer

An alpha-methylstyrene-styrene-acrylonitrile copolymer prepared by copolymerizing a monomer mixture of about 19 wt % of styrene, about 27 wt % of acrylonitrile, and about 54 wt % of alpha-methylstyrene and having a weight average molecular weight of about 160,000 g/mol was used (Manufacturer: Lotte Chemical Corp.).

### (D-4) Alpha-Methylstyrene-Based Copolymer

An alpha-methylstyrene-styrene-acrylonitrile copolymer prepared by copolymerizing a monomer mixture of about 16 wt % of styrene, about 30 wt % of acrylonitrile, about 54 wt % of alpha-methylstyrene and a weight average molecular weight of about 160,000 g/mol was used (Manufacturer: Lotte Chemical Corp.).

### (D-5) Styrene-Acrylonitrile Copolymer

A styrene-acrylonitrile copolymer prepared by copolymerizing a monomer mixture of about 76 wt % of styrene and about 24 wt % of acrylonitrile and having a weight average molecular weight of about 160,000 g/mol was used (Manufacturer: Lotte Chemical Corp.).

### Evaluation

The specimens according to Examples 1 to 7 and Comparative Example 1 to 8 were evaluated with respect to impact resistance, heat resistance, and colorability, and the results are shown in Table 2.

### 1. Impact Resistance (Unit: kgf·cm/cm)

Izod Impact strength of notched ¼″-thick specimens and ⅛″-thick specimens was measured according to ASTM D256.

### 2. Heat Resistance (Unit: ° C.)

Vicat softening temperature (VST) was measured according to ASTM D1525.

### 3. Colorability

A Konica-Minolta CM-3700d colorimeter was used to measure lightness (L) of the specimens with a thickness of 2.5 mm and a size of 90 mm×50 mm in a specular component excluded (SCE) method according to ASTM E308. The lower the lightness, the better the colorability.

### 4. Scratch Resistance

Specimens with a thickness of 2.5 mm and a size of 90 mm×50 mm were scratched with Erichsen scratch tester equipment according to ISO 2409 and then, measured with respect to a change in lightness (Delta L, dL) before and after the scratch to evaluate scratch resistance characteristics. The lightness of the specimens was measured in the specular component excluded (SCE) method by using the Konica-Minolta CM-3700d colorimeter according to ASTM E308. When the specimens were scratched, since fine cracks were generated on the surface of the specimens and thus increased the lightness, the higher the lightness change (dL), the lower the scratch resistance.

### 5. Fluidity (Unit: g/10 min)

Melt flow index (MI) was measured at 220° C. under a weight condition of 10 kg according to ASTM D1238.

TABLE 2

| | Examples | | | | | | | Comparative Examples | | | | | | | |
|---|---|---|---|---|---|---|---|---|---|---|---|---|---|---|---|
| | 1 | 2 | 3 | 4 | 5 | 6 | 7 | 1 | 2 | 3 | 4 | 5 | 6 | 7 | 8 |
| Izod Impact | 11.0 | 10.1 | 9.2 | 9.5 | 9.8 | 9.1 | 10.8 | 9.9 | 9.2 | 6.7 | 10.1 | 9.1 | 7.4 | 12.3 | 9.9 |
| strength (1/4″) | | | | | | | | | | | | | | | |
| Izod Impact | 12.5 | 11.7 | 10.3 | 11.5 | 11.5 | 10.6 | 12.2 | 11.3 | 10.5 | 7.2 | 12.3 | 10.3 | 8.6 | 14.7 | 11.6 |
| strength (1/8″) | | | | | | | | | | | | | | | |
| VST | 100.4 | 99.3 | 99.1 | 98.9 | 99.4 | 99.7 | 99.5 | 99.0 | 99.4 | 98.5 | 100.2 | 95.1 | 94.1 | 96.3 | 95.7 |
| Lightness (L) | 4.6 | 4.2 | 3.8 | 4.2 | 4.2 | 4.1 | 4.2 | 6.1 | 5.8 | 5.4 | 6.3 | 5.7 | 3.4 | 3.6 | 4.4 |
| Scratch | 4.4 | 4.3 | 4.1 | 4.2 | 4.1 | 4.4 | 4.2 | 4.3 | 4.2 | 3.9 | 5.9 | 4.9 | 6.7 | 4.1 | 4.5 |
| resistance (dL) | | | | | | | | | | | | | | | |
| MI | 7.7 | 7.1 | 5.9 | 6.6 | 6.3 | 7.8 | 6.6 | 5.7 | 5.3 | 4.8 | 8.3 | 4.9 | 8.8 | 3.2 | 9.5 |

Referring to the results of Tables 1 to 2, a thermoplastic resin composition including (A) the acrylate-based rubber modified aromatic vinyl-vinyl cyanide graft copolymer, (B) the composite rubber modified aromatic vinyl-vinyl cyanide graft copolymer, (C) the polyalkyl (meth)acrylate resin, and (D) the alpha-methylstyrene-based copolymer within each above-described wt % range and a molded product using the same exhibited all excellent impact resistance, heat resistance, scratch resistance, fluidity, and colorability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A thermoplastic resin composition, comprising
(A) 10 wt % to 30 wt % of an acrylate-based rubber modified aromatic vinyl-vinyl cyanide graft copolymer;
(B) 10 wt % to 30 wt % of a composite rubber modified aromatic vinyl-vinyl cyanide graft copolymer;
(C) 10 wt % to 40 wt % of a polyalkyl (meth)acrylate resin; and
(D) 20 wt % to 50 wt % of an alpha-methylstyrene-based copolymer.

2. The thermoplastic resin composition of claim 1, wherein
the (A) acrylate-based rubber modified aromatic vinyl-vinyl cyanide graft copolymer includes a core including an acrylate-based rubbery polymer, and a shell formed by grafting a monomer mixture including an aromatic vinyl compound and a vinyl cyanide compound to the core.

3. The thermoplastic resin composition of claim 2, wherein
the acrylate-based rubbery polymer is a crosslinked polymer prepared by using an acrylate-based compound including ethyl acrylate, butyl acrylate, 2-ethylhexyl acrylate, hexyl acrylate, or a combination thereof as a main monomer, and the acrylate-based rubbery polymer is included in an amount of 20 wt % to 60 wt % based on 100 wt % of the (A) acrylate-based rubber modified aromatic vinyl-vinyl cyanide graft copolymer.

4. The thermoplastic resin composition of claim 2, wherein
the shell is a copolymer of a monomer mixture including an aromatic vinyl compound and a vinyl cyanide compound in a weight ratio of 1:1 to 4:1.

5. The thermoplastic resin composition of claim 2, wherein
the acrylate-based rubbery polymer has an average particle diameter of 100 nm to 200 nm.

6. The thermoplastic resin composition of claim 1, wherein
the (A) acrylate-based rubber modified aromatic vinyl-vinyl cyanide graft copolymer is an acrylonitrile-styrene-acrylate graft copolymer.

7. The thermoplastic resin composition of claim 1, wherein
the (B) composite rubber modified aromatic vinyl-vinyl cyanide graft copolymer includes a core including a composite rubber polymer, and a shell formed by grafting a monomer mixture including an aromatic vinyl compound and a vinyl cyanide compound to the core.

8. The thermoplastic resin composition of claim 7, wherein
the composite rubber polymer includes a crosslinked copolymer of an acrylate-based compound-silicone-based compound, or a mixture of an acrylate-based rubbery polymer and a silicone-based rubbery polymer, and the composite rubber polymer has an average particle diameter of 100 to 200 nm.

9. The thermoplastic resin composition of claim 1, wherein
the (B) composite rubber modified aromatic vinyl-vinyl cyanide graft copolymer is a copolymer having a core-shell structure in which a styrene-acrylonitrile copolymer (SAN) forms a shell on a core of a crosslinked copolymer of an acrylate-based compound-silicone-based compound.

10. The thermoplastic resin composition of claim 1, wherein
the (C) polyalkyl (meth)acrylate resin has a glass transition temperature of 100° C. to 150° C.

11. The thermoplastic resin composition of claim 1, wherein
the (C) polyalkyl (meth)acrylate resin is polymethyl methacrylate.

12. The thermoplastic resin composition of claim 1, wherein
the (D) alpha-methylstyrene-based copolymer is a copolymer of a monomer mixture including 50 wt % to 60 wt % of alpha-methylstyrene, 15 wt % to 28 wt % of a vinyl cyanide compound, and 15 wt % to 35 wt % of an aromatic vinyl compound, the aromatic vinyl compound is selected from styrene that is substituted or unsubstituted with a halogen or a C1 to C10 alkyl group (but not including alpha-methylstyrene) and a combination thereof, and the vinyl cyanide compound is selected from acrylonitrile, methacrylonitrile, fumaronitrile, and a combination thereof.

13. The thermoplastic resin composition of claim 1, wherein
the (D) alpha-methylstyrene-based copolymer is an alpha-methylstyrene-styrene-acrylonitrile copolymer.

14. The thermoplastic resin composition of claim 1, wherein
the thermoplastic resin composition further includes at least one additive selected from a flame retardant, a nucleating agent, a coupling agent, a filler, a plasticizer, an impact-reinforcing agent, a lubricant, an antibacterial agent, a release agent, a heat stabilizer, an antioxidant, an inorganic material additive, an ultraviolet (UV) stabilizer, an antistatic agent, a pigment, and a dye.

15. A molded product including the thermoplastic resin composition of claim 1.
